(19) United States
(12) Patent Application Publication
(10) Pub. No.: US 2003/0088950 A1
(43) Pub. Date: May 15, 2003

(54) Clasp

(76) Inventors: Chun Yuen To, Hong Kong (CN); Keung Chan, An Oing City (CN)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/037,973

(22) Filed: Nov. 9, 2001

(51) Int. Cl. B42F 13/00; F16B 35/00

(52) U.S. Cl. 24/67 P

(57) ABSTRACT

A clasp for use in fastening loose sheets of paper together in a binder and like usages having three pins for entry in holes in the papers and other items to be fastened together, thereby effecting a triple fastening.

### BACKGROUND OF THE INVENTION

This invention relates to clasps, more particularly to clasps of the type such as used, for example, with a binder for fastening loose sheets of paper together in the binder, or with a backing for fastening loose sheets of paper on the backing, or on a leaf of a file folder, etc.

The invention is especially concerned with a clasp of the type comprising multiple sheet metal bars for binding loose sheets of paper (or the like) in a binder on a cover of the binder, or on a backing, or on a leaf of a file folder, or for binding a leaf of papers per se, or like usage.

The invention involves what may be regarded as an improvement on a dual-pin clasp predecessor.

### SUMMARY OF THE INVENTION

Among the several objects of the invention may be noted the provision of a clasp of the type above described having improved fastening or binding capability; the provision of such a clasp adapted for manufacture of sheet metal in quantity production; and the provision of such a clasp for sale in compact form and of convenient applicability by the user.

In general, a clasp of this invention comprises multiple elongate sheet metal bars. A first bar has a plurality of pin-receiving holes therein, one adjacent one end thereof, one adjacent the other end, and at least one intermediate the ends. A second bar has a length corresponding generally to the distance measured lengthwise of the first bar between one of the holes adjacent one end thereof and one of the at least one intermediate holes in the first bar, and a plurality of bendable sheet metal pins thereon, one having a bendable junction therewith at one end thereof, one having a bendable junction therewith at the other end thereof. The pins are bendable at the junctions to a hole-entry position generally at right angles to the second bar for extending through holes in items to be bound together and thence through the holes in the first bar. Portions of the pins extending through the holes are bendable over on the first bar, the latter having pin holders positionable thereon in pin-freeing position enabling the pins to be bent at the junctions to the said hole-entry position and a pin-holding position, for initially holding the pins bent over at the junctions on the first bar and for holding said portions bent over on the first bar after their entry through the holes in said items and the first bar.

In one preferred form of the present invention, a clasp of this invention comprises a first and a second elongate sheet metal bar. The first bar has a plurality of pin-receiving holes therein, one adjacent one end thereof, one adjacent the other end, and at least one intermediate the ends. The second bar has a length corresponding generally to the distance measured lengthwise of the first bar between the holes in the first bar, and a plurality of bendable sheet metal pins thereon, one having a bendable junction therewith at one end thereof, one having a bendable junction therewith at the other end thereof, and at least one having a bendable junction therewith intermediate the ends thereof. The pins are bendable at the junctions to a hole-entry position generally at right angles to the second bar for extending through holes in items to be bound together and thence through the holes in the first bar. Portions of the pins extending through the holes are bendable over on the first bar, the latter having pin holders positionable thereon in pin-freeing position enabling the pins to be bent at the junctions to the said hole-entry position and a pin-holding position, for initially holding the pins bent over at the junctions on the first bar and for holding said portions bent over on the first bar after their entry through the holes in said items and the first bar.

In another preferred form of the present invention, there is a first elongate sheet metal bar having a plurality of pin-receiving holes therein, one adjacent one end of the first bar, one adjacent the other end of the first bar, and one substantially in the middle of the first bar; two second bars each having a length approximately one-half of the length of the first bar and each having a bendable sheet metal pin at each end thereof; said pins being bendable at their junctions with the second bars to a hole-entry position generally at right angles to the second bar for extending through holes in items to be bound together and thence through the holes in the first bar, portions of the pins extending through the holes being bendable over on the first bar; the first bar having pin holders positionable thereon in pin-freeing position enabling the pins to be bent at the junctions to the said hole-entry position and pin-holding position for initially holding the pins bent over at the junctions on the first bar and for holding said portions bent over on the first bar after their entry through the holes in said items and the first bar.

Other objects and features will be in part apparent and in part pointed out hereinafter.

### BRIEF DESCRIPTION OF THE DRAWINGS

FIG. 1 is an exploded perspective of a first embodiment of a clasp of the invention, showing the two bars of the clasp disassembled with the lowermost-shown bar prepared for assembly with items to be bound;

FIG. 2 is a view in side elevation of the uppermost bar of FIG. 1;

FIG. 3 is a view in side elevation of FIG. 1;

FIG. 4 is a view in plan of the clasp with the bars assembled;

FIGS. 5 and 6 are perspectives illustrating stages in the use of the clasp with a binder;

FIG. 7 is an exploded perspective showing the individual parts of FIG. 1;

FIG. 7A is a perspective of the clasp with the bars thereof assembled and the pins thereof bent over as initially supplied in compact form (e.g. for sale);

FIGS. 8-14A are views similar to FIGS. 1-7A, respectively, showing a modification;

FIGS. 15-28 are views illustrating seven different versions of the securement of the center pin to the lowermost bar; and

FIG. 29 is a perspective view of another embodiment of the present invention.

Corresponding reference characters indicate corresponding parts throughout the several views of the drawings.

### DETAILED DESCRIPTION OF THE PREFERRED EMBODIMENTS

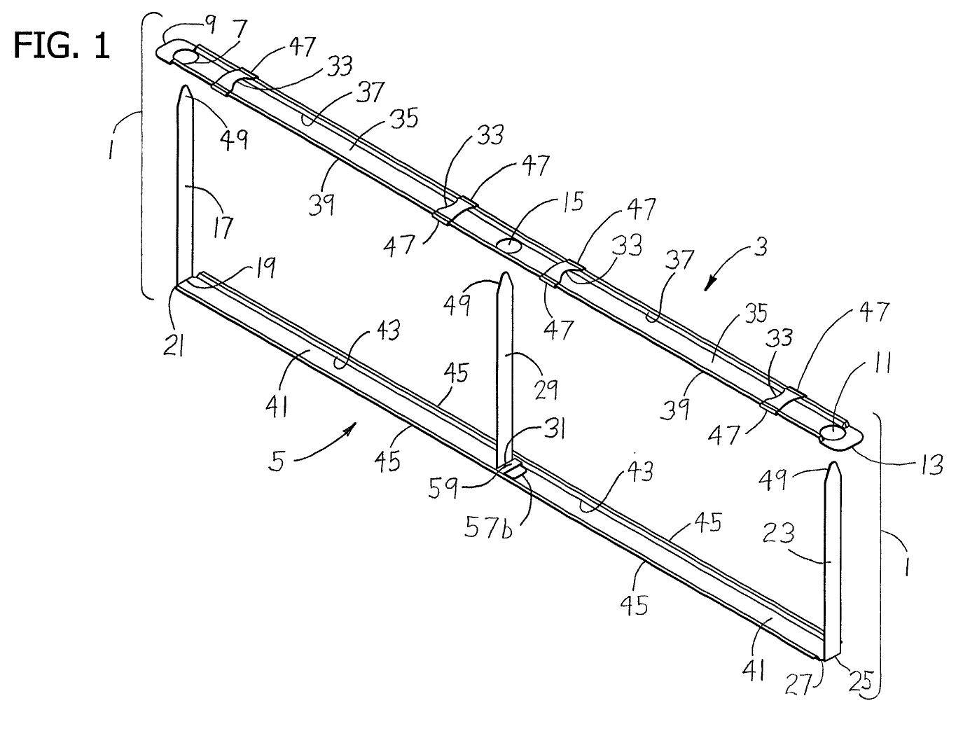

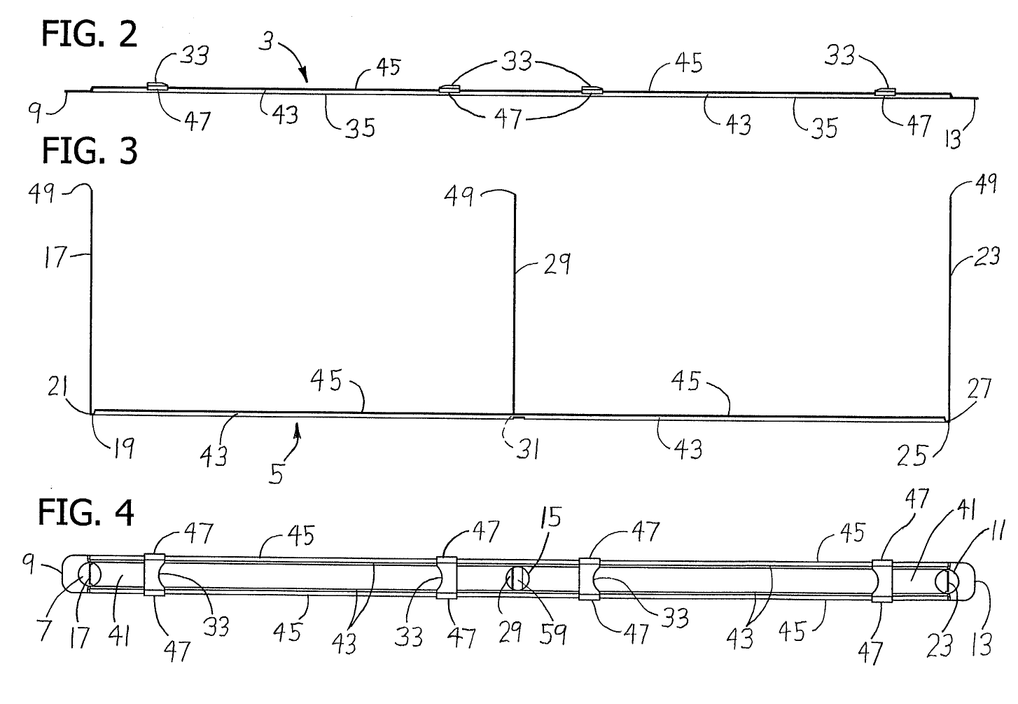

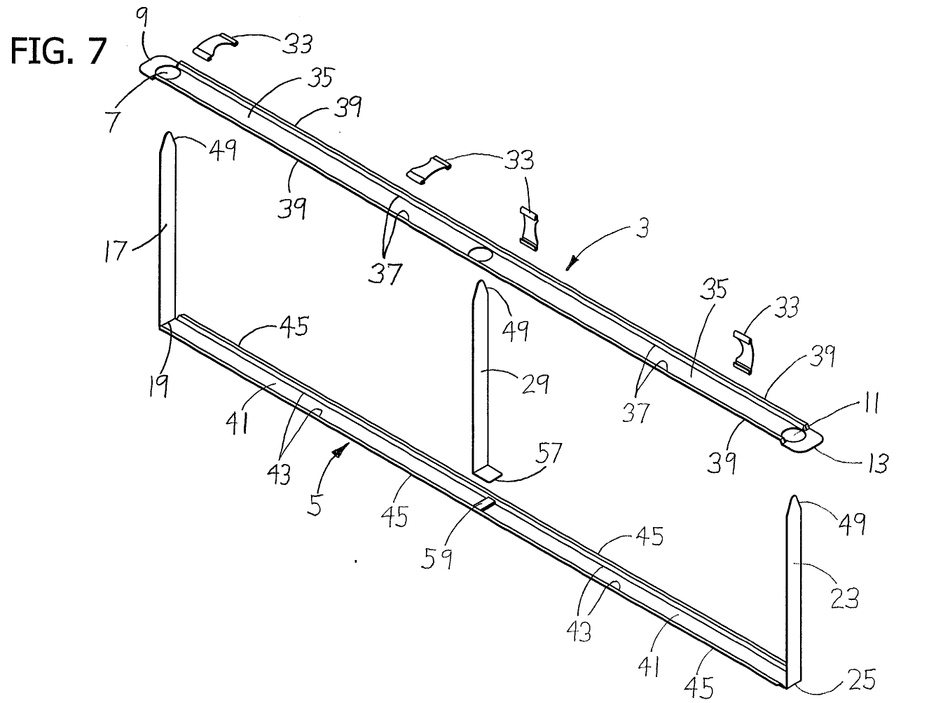

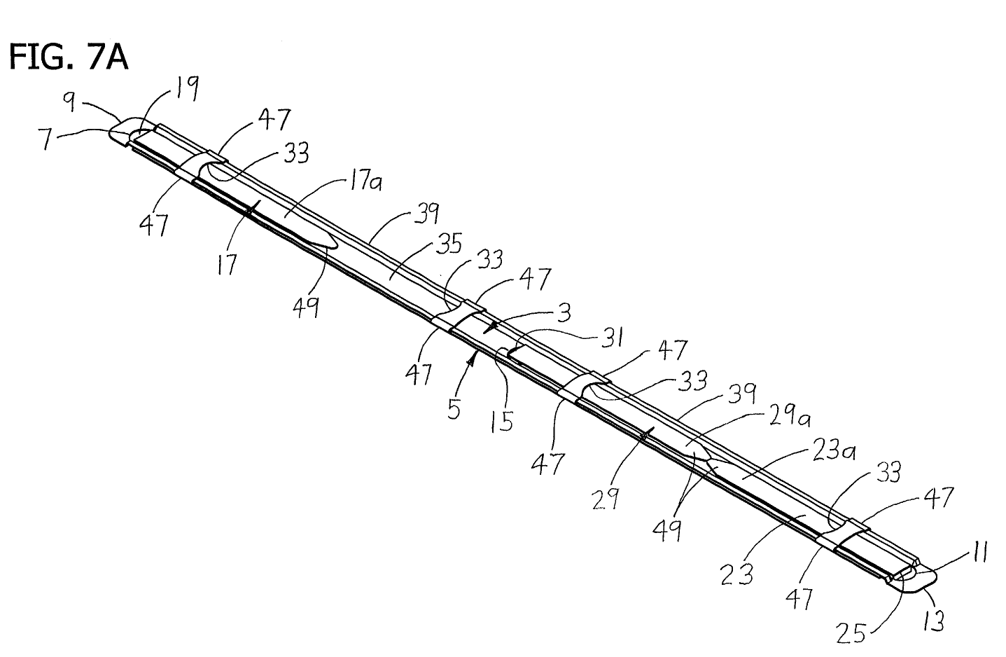

First referring to FIGS. 1-4, 7 and 7A, a first embodiment of a clasp of this invention, designated 1 in its entirety, is shown to comprise first and second elongate sheet metal bars 3 and 5, the first showing as the uppermost of the two bars in FIGS. 1 and 7, the second as the lowermost bar. Each of these bars is typically of sheet tin plated steel of 0.012 gauge (i.e. 0.3 mm thick), bar 3 typically being about 9⅜ inches (24 centimeters) long and 9/16 inch (one centimeter) wide overall bar 5 being somewhat shorter and of the same width overall. The dimensions may be other than described without departing from the scope of the present invention.

The first bar 3 has a plurality of pin-receiving holes therein, one designated 7 adjacent one end 9 of the bar 3, one designated 11 adjacent the other end 13 of the bar 3, and at least one such as indicated at 15 intermediate the ends of the bar 3. The second bar 5 has a length corresponding generally to the distance measured lengthwise of bar 3 between the holes 7, 11 adjacent the ends of bar 3. The second bar 5 has a plurality of bendable sheet metal pins thereon (generally the same sheet metal as the bars), one designated 17 having a bendable junction 19 with bar 5 at the end 21 of the bar 5, one designated 23 having a bendable junction 25 with bar 5 at the other end 27 of bar 5, and at least one such as indicated at 29 having a bendable junction 31 with bar 5 intermediate the ends of bar 5. It is to be understood that, in use, the pins 17, 23, 29 are bendable other than at the junctions 19, 25, 31 in conformance with the height of the stack of paper held by the clasp 1.

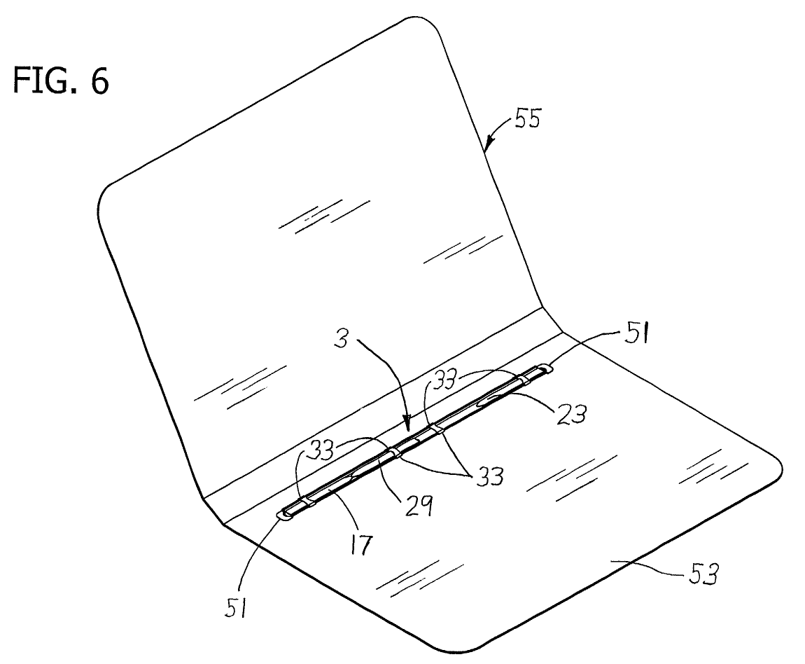

The pins 17, 23, 29 are bendable at the junctions 19, 25, 31 to a position for entry in holes of a bundle of items to be bound together (as will be described) and in the holes 7, 11, 15 in bar 3, denoted their hole-entry position, in which they extend generally at right angles to bar 5, as shown in FIG. 1. Portions of the pins extending through the holes in said items and through holes 7, 11, 15 of the bar 3 are bendable over on the bar 3. The latter has a plurality of pin holders such as indicated at 33 positionable thereon in a pin-freeing position (as will be described) enabling the pins to be bent at the junctions 19, 25, 31 to the stated hole-entry position (of FIG. 1) and a pin-holding position (such as illustrated in FIGS. 6 and 7A) for initially holding the pins bent over on bar 3 at the junctions and for holding the aforesaid portions bent over on bar 3 after entry of the pins through the holes in the aforesaid items and the holes 7, 11, 15. The pin holders are slidable on bar 3 between their pin-holding and pin-freeing positions as will be subsequently more fully described.

The first bar 3 comprises an elongate sheet metal channel, e.g. of 0.012 gauge tin plated steel, having a web 35 and flanges 37, with lips 39 extending laterally outward from the edges of the flanges. The holes 15 in bar 3 are in the web 35 thereof. The second bar 5 also comprises a sheet metal channel, of the same sheet metal as bar 3, having a web 41 and flanges 43 with lips 45 extending laterally outward from the edges of the flanges. The bars are dimensioned (in transverse cross-section) for bar 3 to nest in bar 5 (being so shown in FIG. 7A). Each of the pin holders 33 comprises a narrow band of sheet metal slidable on the lips 39 of the bar 3, the ends of each band being bent around the lips as indicated at 47.

The pins 17, 23 extending from the ends of the bar 5 are integral extensions of the bar 5 (more precisely extensions of web 41 of the bar 5). The pin 29 comprises a strip of sheet metal somewhat narrower than web 41 fastened at one end thereof to the bar 5 (more precisely to the web 41). Pin 29 is shown as fastened to bar 5 generally at the center of length of bar 5 (i.e., midway between pins 17 and 23). Each pin has its distal end tapered to be pointed, as indicated at 49.

The clasp 1 is supplied in an initial format (FIG. 7A) wherein bar channel 3 lies on the second bar channel 5, more precisely wherein bar or channel 3 is nested in the second bar or channel 5, the pins 17, 29, 23 extend through the holes 7, 15, 11, portions 17a, 29a, 23a of the pins which extend past the holes being bent over on the bar 3 (more precisely on the web 35), the pin holders 33 being slid along the bar 3 to an out-of-the-way position permitting this, and the bent-over portions are held down by sliding the pin holders to pin-holding positions over the pins such as shown in FIG. 7A. For use, the pin holders are slid to a pin-freeing position, and the pins are bent up to the positions in which they appear in FIG. 1, bars 3 and 5 being separated.

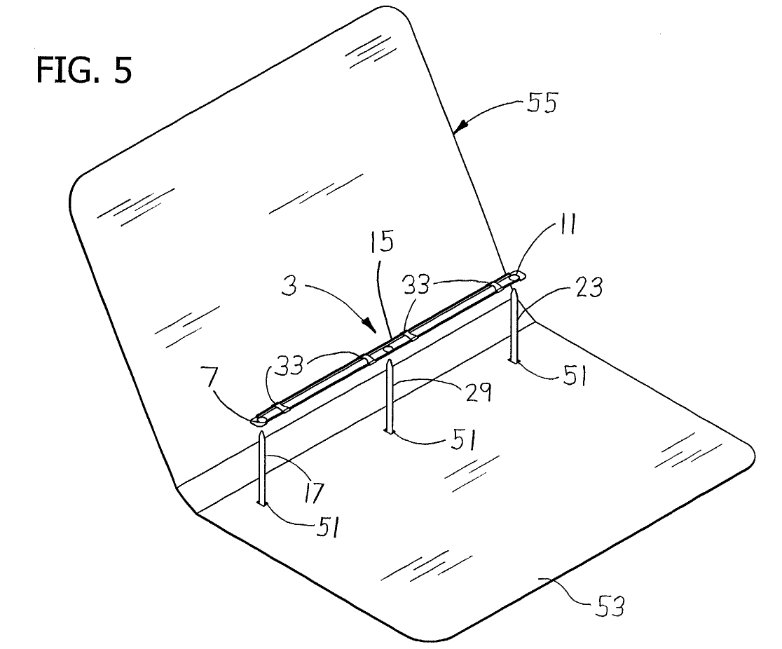

FIG. 5 shows the pins 17, 29, 23 extending up through holes 51 in the back cover 53 of a binder 55 (bar 5 being underneath the back cover 53). A bundle of papers (not shown) having holes for receiving the pins is applied to the pins and held down on the back cover by applying the bar 3 to the pins, bending over the portions of the pins extending above the bundle on the bundle, and sliding the pin holders to pin-holding position as shown in FIG. 6.

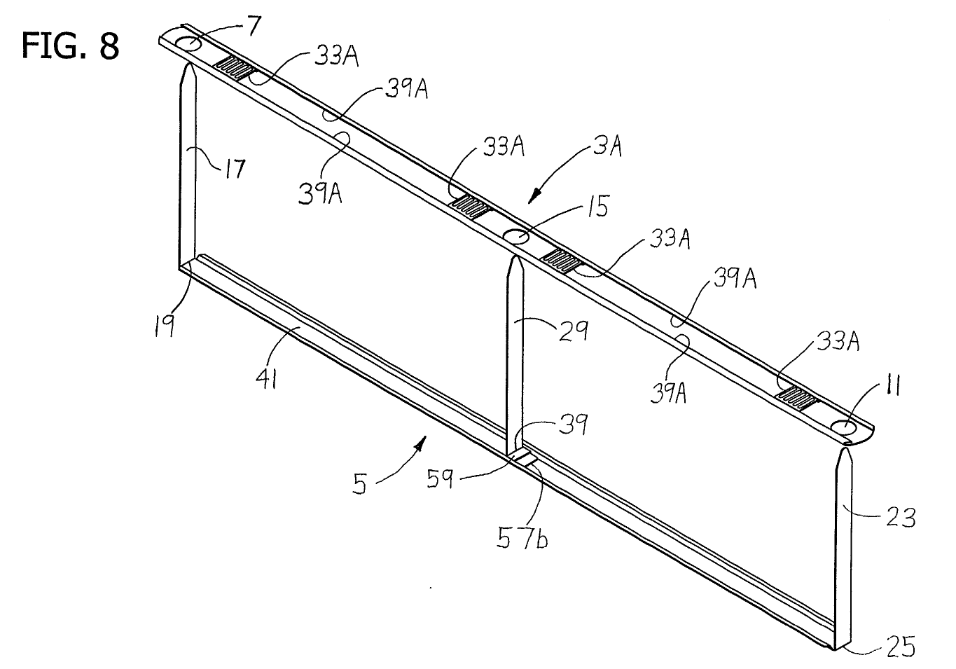

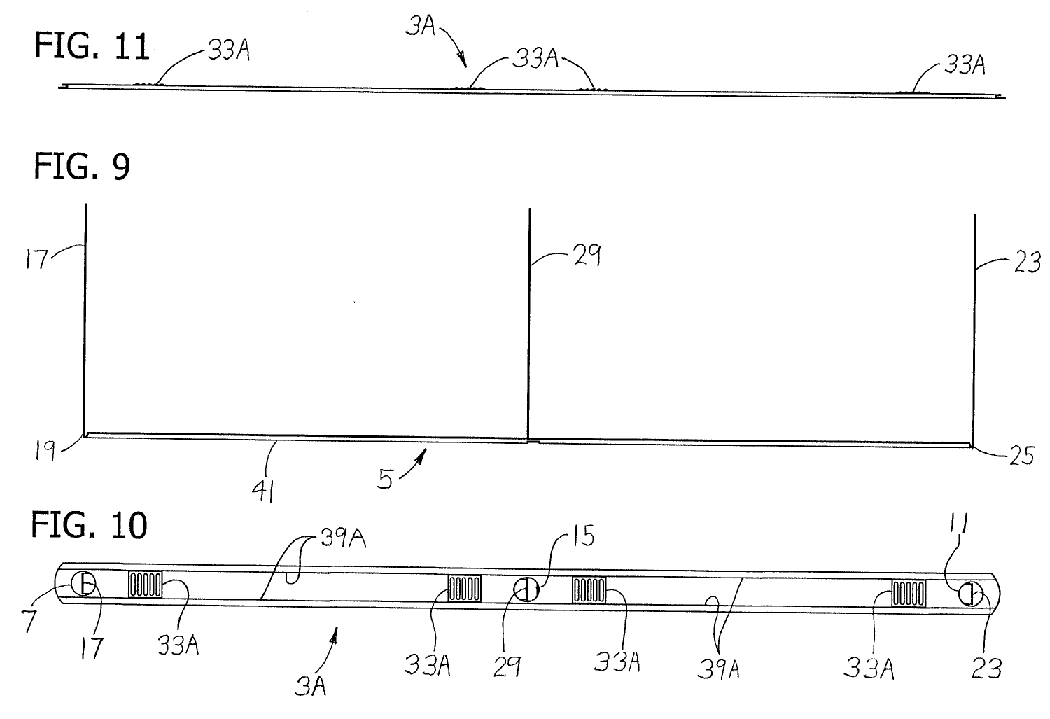

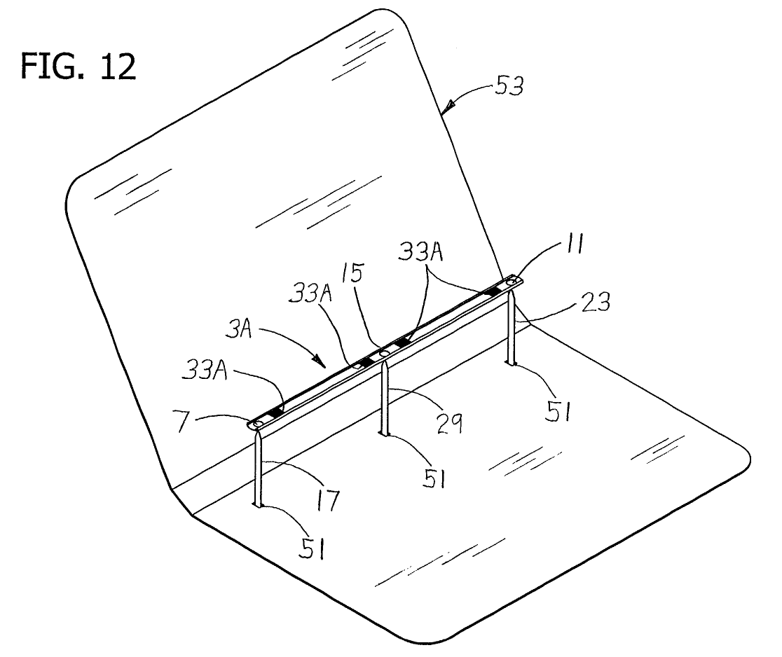

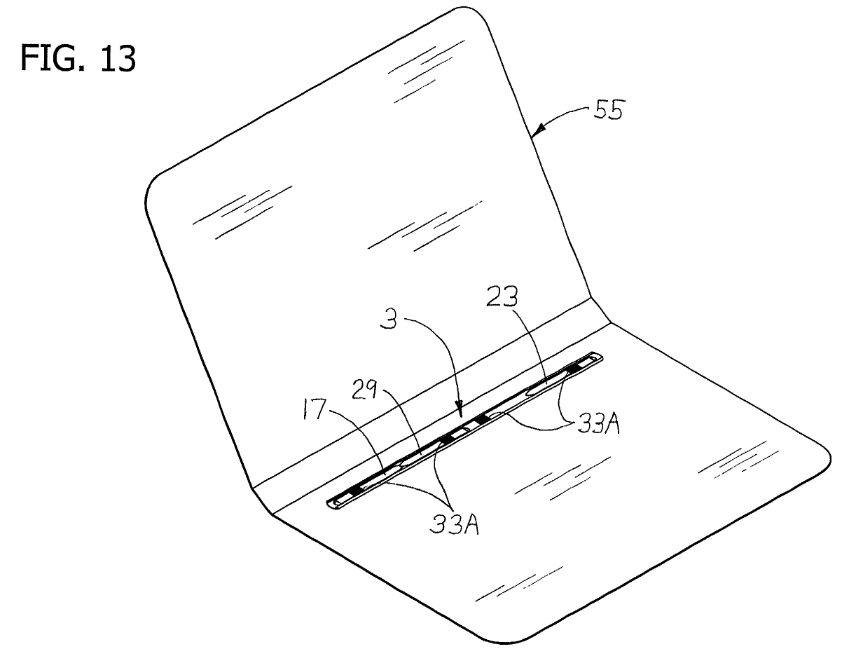

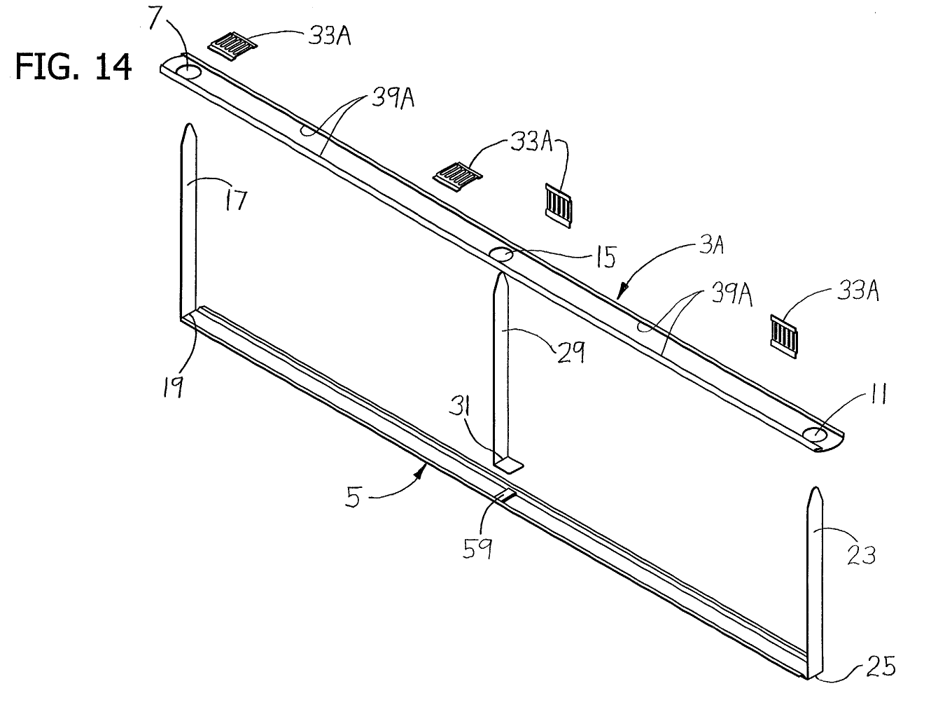

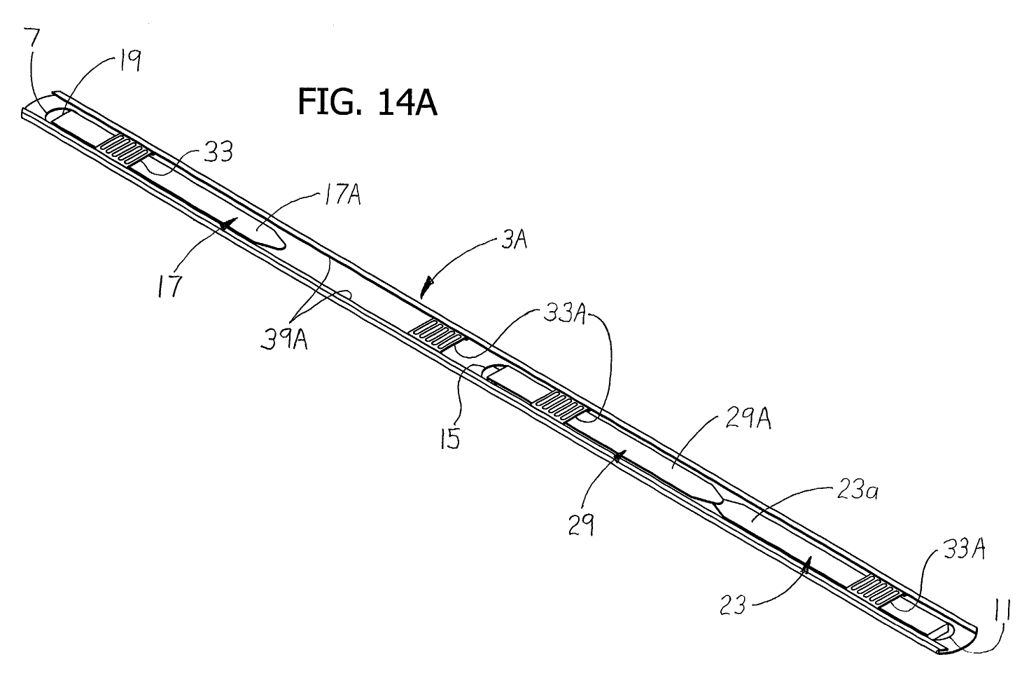

FIGS. 8-14A, correspond to FIGS. 1-7A, respectively, illustrating a modification wherein bar 3A has in-turned lips 39A instead of the out-turned lips 39 and the pin holders comprise knurled bands 33A of sheet metal held captive by the lips 39A slidable along bar 3A. Aside from reference characters 3A, 33A and 39A, the same reference numbers are used in FIGS. 8-14A as in FIGS. 1-7A for the corresponding parts.

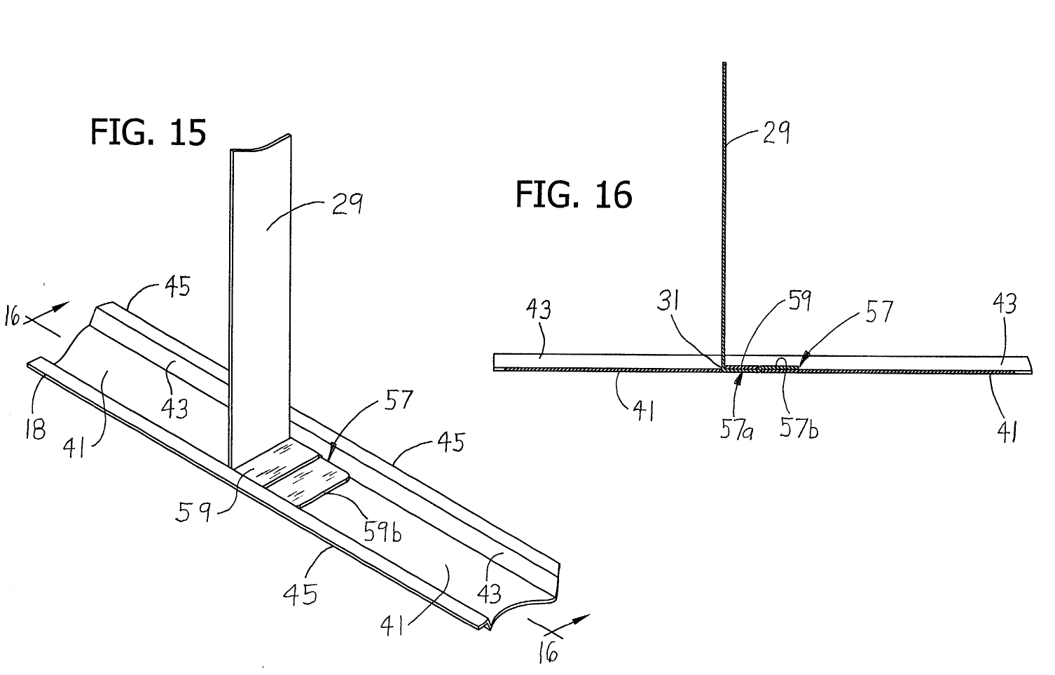

In the clasp 1 as shown in FIGS. 1, 7, 15 and 16, the intermediate (center) pin 29 is fastened to the bar 5 (more precisely to the web 41 of the bar or channel 5) by having a foot 57 bent to extend at an angle (more precisely at right angles) thereto extending under a strap 59 struck up from the web extending transversely thereof. As shown in FIG. 16, part 57a of the foot occupies the opening resulting from striking the strap up out of the web 41 and the distal part 57b of the foot overlies the web 41.

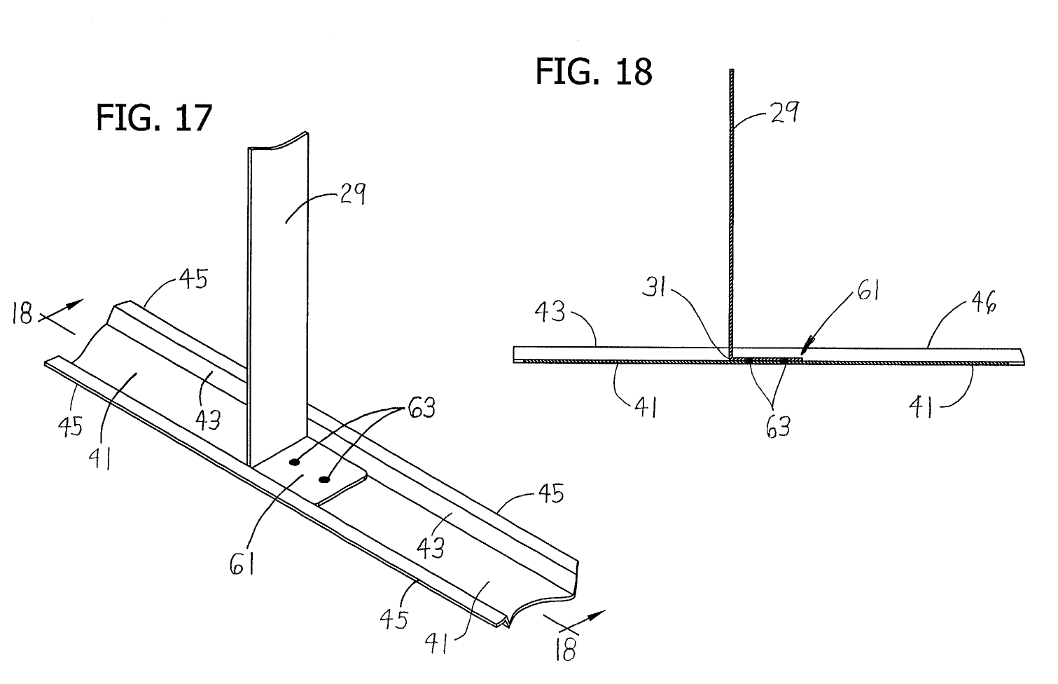

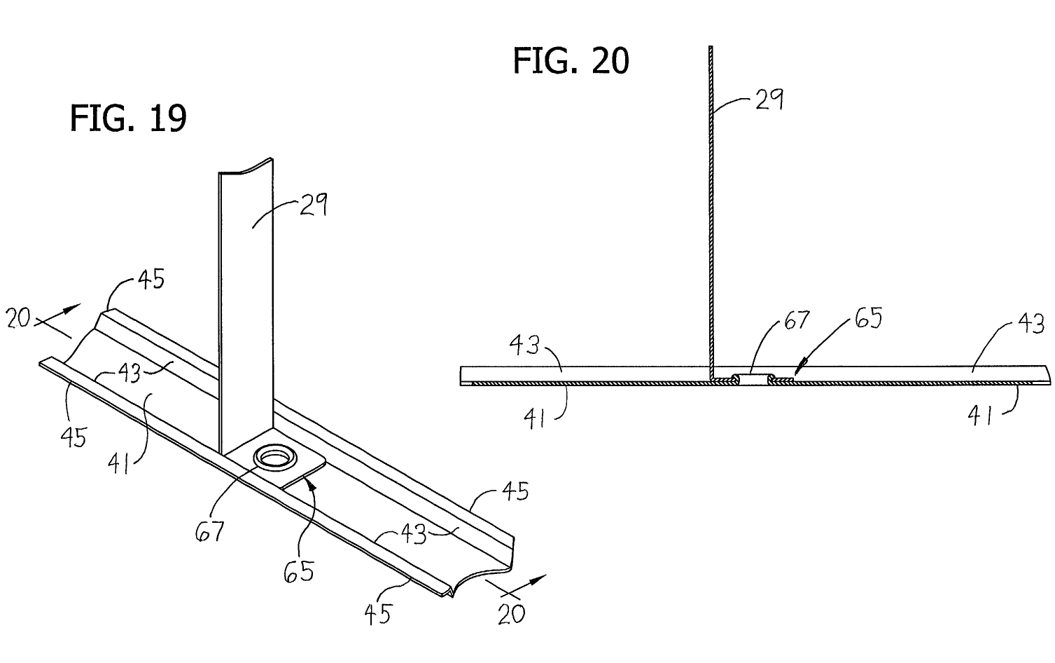

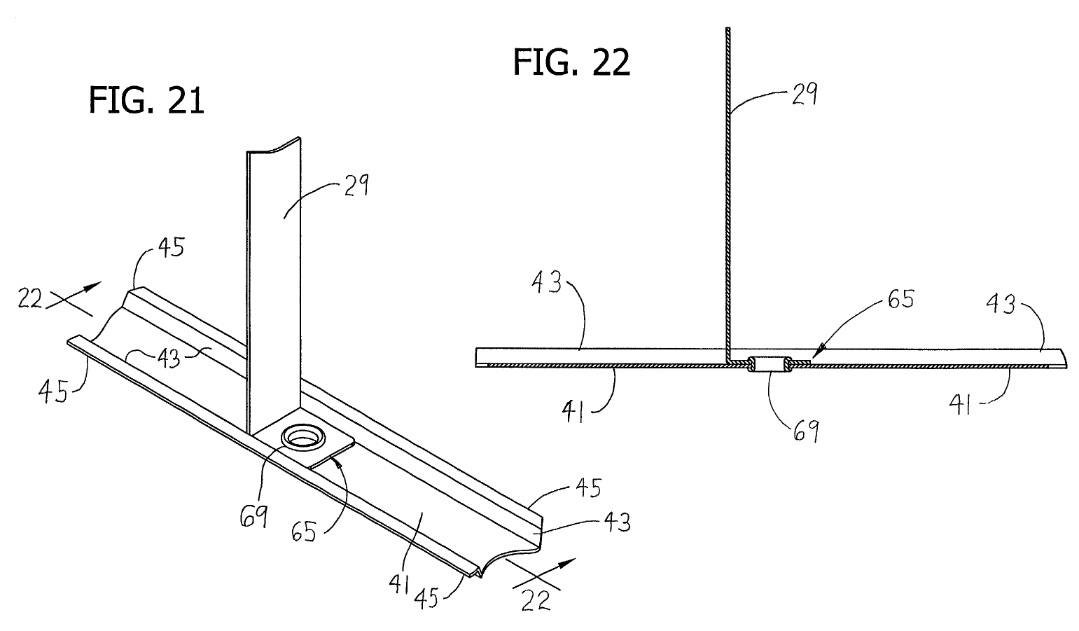

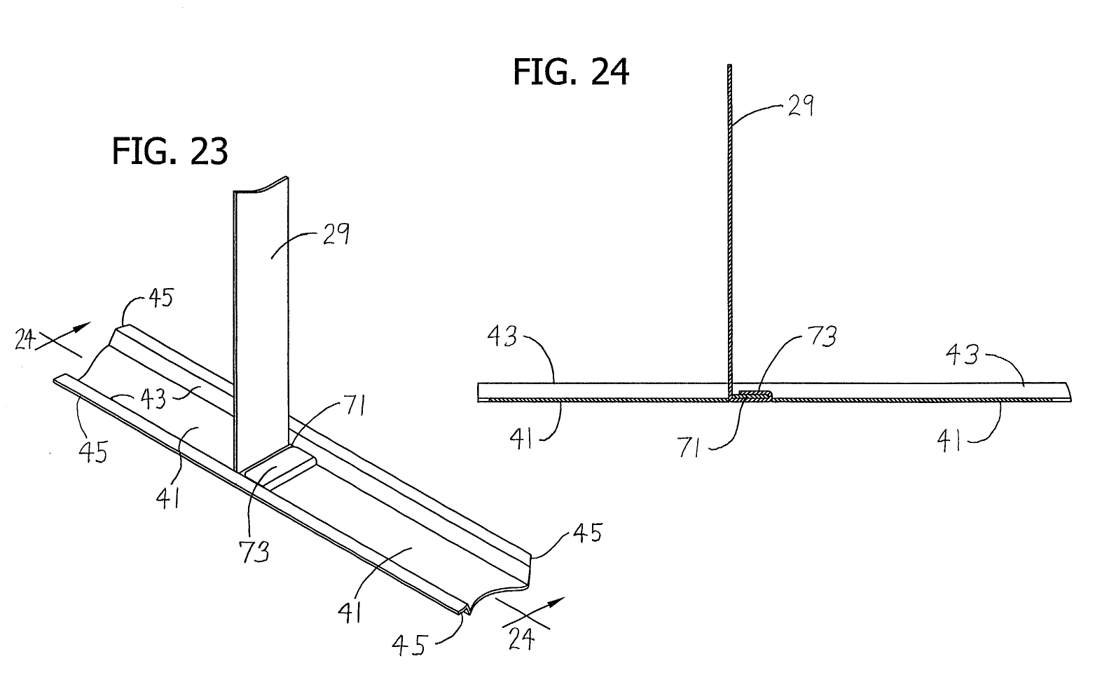

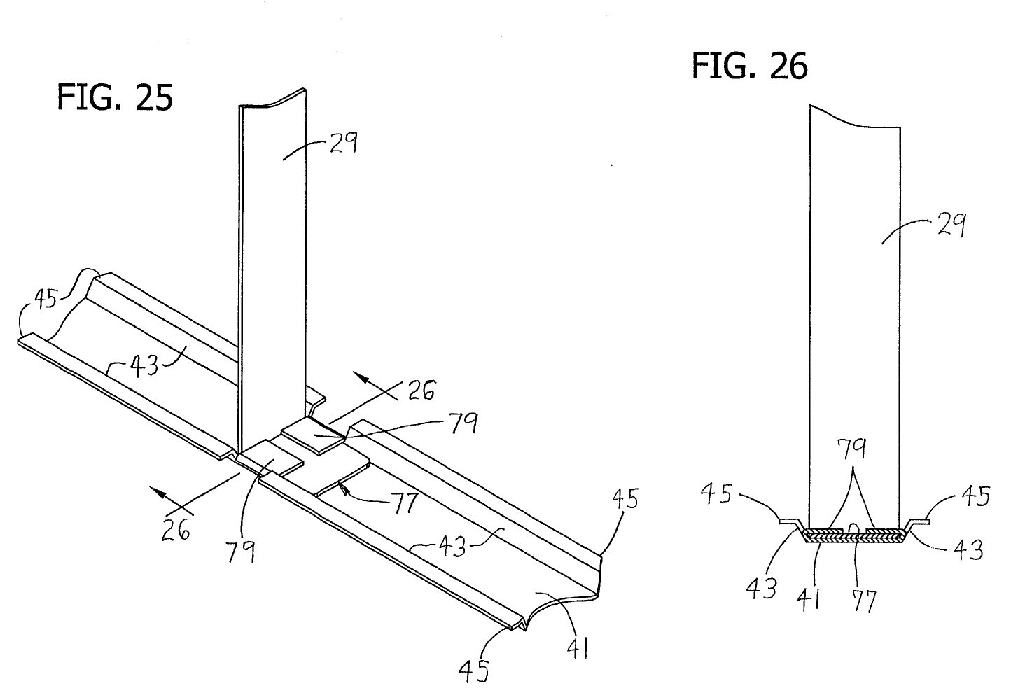

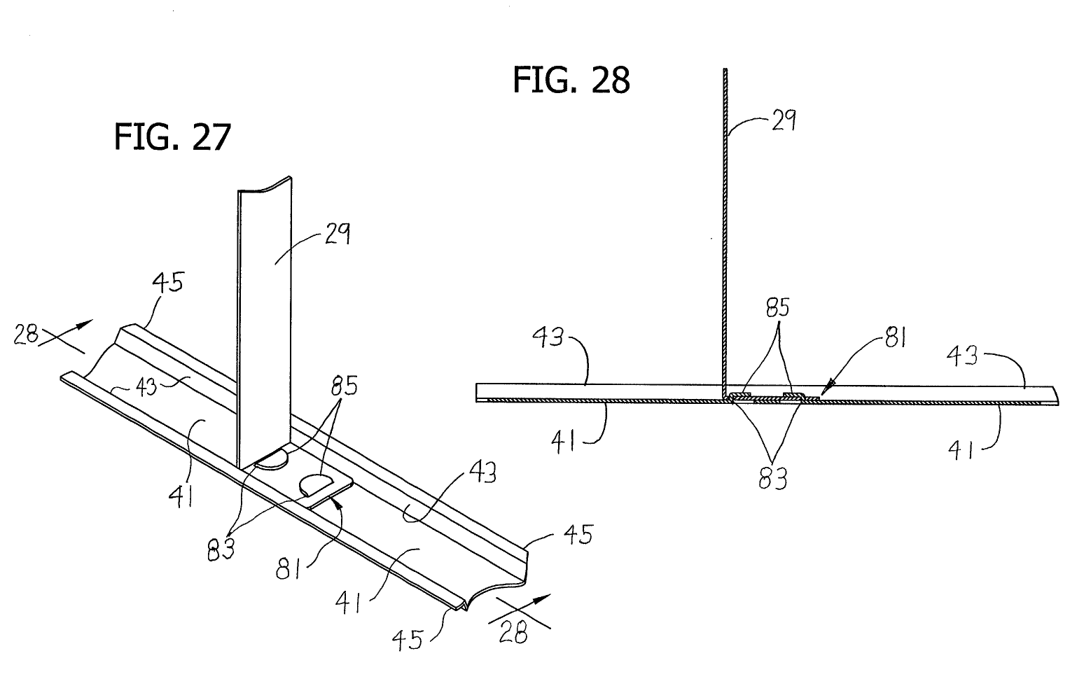

Alternatively, the foot may be flat as indicated at 61 in FIGS. 17 and 18 and spot-welded as indicated at 63 to the web. Or flat as indicated at 65 in FIGS. 19-22 and riveted in place on web 41 either by a rivet 67 struck from the web 41 (FIGS. 19 and 20) or by a separate rivet 69 (FIGS. 21 and 22). Or by being short and flat as indicated at 71 and extending under a strap 73 struck up from the web 41 and its distal end bent back as indicated at 75 over the strap 73 (FIGS. 23 and 24). Or flat as indicated at 77 in FIGS. 25 and 26 and held down on web 41 by tabs 79 constituted by bent-over segments of the sides of the bar. Or flat as indicated at 81 in FIGS. 27 and 28 and having holes 83 receiving tabs 85 struck from the web and bent over on the foot.

Any one of the arrangements above described for fastening pin 29 to the bar 5 may be used for fastening the pin 29 to the bar 3A.

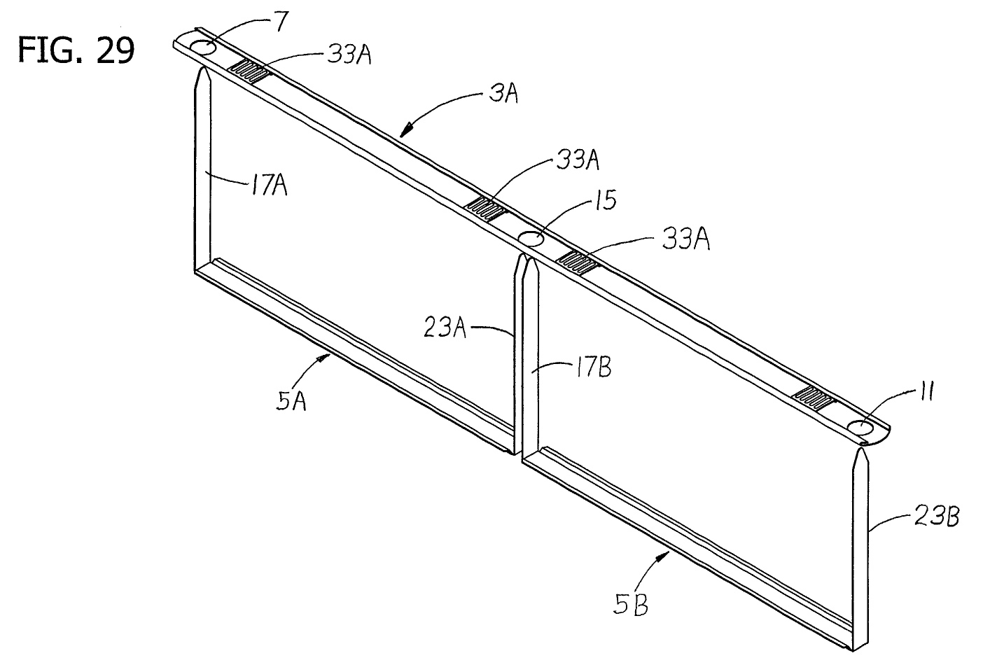

The alternative embodiment illustrated in FIG. 29 utilizes the bar 3A of the prior embodiment although it is to be understood that bar 3 could also be utilized. In this embodiment there are two bars 5A and 5B of identical construction and length equal to substantially half the length of bar 3A. Bar 5A has pins 17A and 23A and bar 5B has pins 17B and 23B, which are identical to pins 17 and 23 of bar 5. In this embodiment pins 23A and 17B are both inserted in hole 15 of bar 3A and can be bent outwardly away from each other and secured by pin holders 33A.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A clasp comprising:
a first elongate sheet metal bar having a plurality of pin-receiving holes therein, one adjacent one end of the first bar, one adjacent the other end of the first bar, and at least one intermediate the ends of the first bar;
at least one second bar having a length corresponding generally to the distance measured lengthwise of the first bar between any two of the holes of the first bar; the at least one second bar having a plurality of bendable sheet metal pins thereon, one having a bendable junction with the second bar at one end thereof, one having a bendable junction with the second bar at the other end thereof; said pins being bendable at the junctions to a hole-entry position generally at right angles to the second bar for extending through holes in items to be bound together and thence through the holes in the first bar, portions of the pins extending through the holes being bendable over on the first bar; the first bar having pin holders positionable thereon in pin-freeing position enabling the pins to be bent at the junctions to the said hole-entry position and pin-holding position for initially holding the pins bent over at the junctions on the first bar and for holding said portions bent over on the first bar after their entry through the holes in said items and the first bar.

2. A clasp as set forth in claim 1 wherein the pins extending from the ends of said at least one second bar are integral extensions of the at least one second bar.

3. A clasp as set forth in claim 1 wherein the pin holders are slidable on the first bar between their pin-holding position and pin-freeing positions.

4. A clasp as set forth in claim 1 wherein each bar comprises a sheet metal channel having a web and flanges with lips extending laterally outward from the edges of the flanges, the holes in the first bar being in the web thereof, the pins extending from the ends of the at least one second bar being integral extensions of the web thereof, the pin holders being slidable on the lips of the first bar.

5. A clasp as set forth in claim 1 in an initial format wherein the first bar lies on the at least one second bar, the pins extend through the holes in the first bar, said portions of the pins being bent over on the first bar and held down thereon by said pin holders.

6. A clasp as set forth in claim 4 in an initial format wherein the first bar is nested in the at least one second bar, the pins extend through the holes in the first bar, said portions of the pins being bent over on the first bar and held down thereon by said pin holders.

7. A clasp as set forth in claim 1 wherein the first bar comprises an elongate bar of sheet metal having the longitudinal margins thereof bent over so as to overlie the bar, the pins extending from the ends of the at least one second bar being integral extensions thereof, the pin holders being slidable on the first bar underneath the bent-over margins thereof.

8. A clasp as set forth in claim 1 wherein there are two second bars and 3 pin-receiving holes in the first bar.

9. A clasp as set forth in claim 8 wherein the two second bars are of equal length and the intermediate pin-receiving hole is substantially in the center of the first bar.

10. A clasp comprising a first and a second elongate sheet metal bar; the first bar having a plurality of pin-receiving holes therein, one adjacent one end of the first bar, one adjacent the other end of the first bar, and at least one intermediate the ends of the first bar; the second bar having a length corresponding generally to the distance measured lengthwise of the first bar between the holes adjacent the ends of the first bar; the second bar having a plurality of bendable sheet metal pins thereon, one having a bendable junction with the second bar at one end thereof, one having a bendable junction with the second bar at the other end thereof, and at least one having a bendable junction with the second bar intermediate the ends thereof; said pins being bendable at the junctions to a hole-entry position generally at right angles to the second bar for extending through holes in items to be bound together and thence through the holes in the first bar, portions of the pins extending through the holes being bendable over on the first bar; the first bar having pin holders positionable thereon in pin-freeing position enabling the pins to be bent at the junctions to the said hole-entry position and pin-holding position for initially holding the pins bent over at the junctions on the first bar and for holding said portions bent over on the first bar after their entry through the holes in said items and the first bar.

11. A clasp as set forth in claim 10 wherein the pins extending from the ends of said second bar are integral extensions of the second bar and the said at least one intermediate pin comprises a strip of sheet metal secured at one end thereof to the second bar.

12. A clasp as set forth in claim 10 wherein the pin holders are slidable on the first bar between their pin-holding position and pin-freeing positions.

13. A clasp as set forth in claim 10 wherein each bar comprises a sheet metal channel having a web and flanges with lips extending laterally outward from the edges of the flanges, the holes in the first bar being in the web thereof, the pins extending from the ends of the second bar being integral extensions of the web thereof, the at least one intermediate pin comprising a strip of sheet metal secured at one end to the web of the second bar, the pin holders being slidable on the lips of the first bar.

14. A clasp as set forth in claim 10 in an initial format wherein the first bar lies on the second bar, the pins extend through the holes in the first bar, said portions of the pins being bent over on the first bar and held down thereon by said pin holders.

15. A clasp as set forth in claim 13 in an initial format wherein the first bar is nested in the second bar, the pins extend through the holes in the first bar, said portions of the pins being bent over on the first bar and held down thereon by said pin holders.

16. A clasp as set forth in claim 10 wherein the first bar comprises an elongate bar of sheet metal having the longitudinal margins thereof bent over so as to overlie the bar, the pins extending from the ends of the second bar being integral extensions thereof, the at least one intermediate pin comprising a strip of sheet metal secured at one end to the second bar, the pin holders being slidable on the first bar underneath the bent-over margins thereof.

17. A clasp as set forth in claim 11 wherein the at least one intermediate pin is secured at said one end thereof to the second bar by having a foot bent to extend at an angle thereto fastened to the second bar.

18. A clasp as set forth in claim 17 wherein the foot is fastened to the second bar by its extending under part of the second bar struck from the second bar.

19. A clasp as set forth in claim 18 wherein said part of the second bar comprises a strap extending transversely with respect to the second bar and part of the foot occupies a position in the opening in the second bar resulting from striking it out of the bar and the distal part of the foot overlies the second bar.

20. A clasp as set forth in claim 17 wherein the foot is spot-welded to the second bar.

21. A clasp as set forth in claim 17 wherein the foot is fastened to the second bar by a rivet.

22. A clasp as set forth in claim 21 wherein the rivet is struck from the second bar.

23. A clasp as set forth in claim 21 wherein the rivet is a separate part.

24. A clasp as set forth in claim 18 wherein said part of the second bar comprises a strap extending transversely with respect to the second bar and the distal end of the foot is bent back over the strap.

25. A clasp as set forth in claim 17 wherein said foot is fastened to the second bar by tabs constituted by bent-over segments of the sides of the second bar.

26. A clasp as set forth in claim 17 wherein said foot is fastened to the second bar by tabs struck from the second bar extending through holes in the foot and bent over on the foot.

27. A clasp comprising a first and a second elongate sheet metal channel each having a web and flanges; the web of the first channel having a plurality of pin-receiving holes therein, one adjacent one end of the first channel, one adjacent the other end of the first channel, and at least one intermediate the ends of the first channel; the second channel being nested in the first channel and having a length corresponding generally to the distance measured lengthwise of the first channel between the holes adjacent the ends of the first channel; the second channel having a plurality of bendable sheet metal pins thereon, one having a bendable junction with the web of the second channel at one end thereof, one having a bendable junction with the web of the second channel at the other end thereof, and at least one having a bendable junction with the web of the second channel intermediate the ends thereof, said pins being bendable at the junctions to a hole-entry position generally at right angles to the second channel for extending through holes in items to be bound together and thence through the holes in the first channel, portions of the pins extending through the holes being bendable over on the web of the first channel; the first channel having pin holders positionable thereon in pin-freeing position enabling the pins to be bent at the junctions to the said hole-entry position and pin-holding position for initially holding the pins bent over at the junctions on the web of the first channel and for holding said portions bent over on the web of the first channel after their entry through the holes in said items and the first channel.

28. A clasp as set forth in claim 27 wherein the pins extending from the ends of said second channel are integral extensions of the web of the second channel and the said at least one intermediate pin comprises a strip of sheet metal secured at one end thereof to the web of the second channel.

29. A clasp as set forth in claim 27 wherein the pin holders are slidable on the first channel between their pin-holding position and pin-freeing positions.

30. A clasp as set forth in claim 27 wherein each channel has lips extending laterally outward from the edges of its flanges, the pins extending from the ends of the second channel being integral extensions of the web thereof, the at least one intermediate pin comprising a strip of sheet metal secured at one end to the web of the second channel, the pin holders being slidable on the lips of the first channel.

31. A clasp as set forth in claim 27 wherein the first channel has its flanges bent over so as to overlie its web, the pin holders being slidable on the first channel underneath the bent-over flanges thereof.

32. A clasp as set forth in claim 28 wherein the at least one intermediate pin is secured at said one end thereof to the web of the second channel by having a foot bent to extend at an angle thereto fastened to the second channel.

33. A clasp as set forth in claim 32 wherein the foot is fastened to the web of the second channel by its extending under part of the web of the second channel struck from the web of the second channel.

34. A clasp as set forth in claim 33 wherein said part of the web of the second channel comprises a strap extending transversely with respect to the second channel and part of the foot occupies a position in the opening in the web of the second channel resulting from striking it out of the web of the second channel and the distal part of the foot overlies the web of the second channel.

35. A clasp as set forth in claim 32 wherein the foot is spot-welded to the web of the second channel.

36. A clasp as set forth in claim 32 wherein the foot is fastened to the web of the second channel by a rivet.

37. A clasp as set forth in claim 36 wherein the rivet is struck from the web of the second channel.

38. A clasp as set forth in claim 36 wherein the rivet is a separate part.

39. A clasp as set forth in claim 33 wherein said part of the web of the second channel comprises a strap extending transversely with respect to the second channel and the distal end of the foot is bent back over the strap.

40. A clasp as set forth in claim 32 wherein said foot is fastened to the second channel by tabs constituted by bent-over segments of the sides of the second channel.

41. A clasp as set forth in claim 32 wherein said foot is fastened to the web of the second channel by tabs struck from the web of the second channel extending through holes in the foot and bent over on the foot.
